(19) United States
(12) Patent Application Publication
(10) Pub. No.: US 2014/0316913 A1
(43) Pub. Date: Oct. 23, 2014

(54) METHOD AND CLIENT FOR DISPLAYING ADVERTISEMENTS

(71) Applicant: TENCENT TECHNOLOGY (SHENZHEN) COMPANY LIMITED, Shenzhen (CN)

(72) Inventors: Zhiqiang HE, Shenzhen (CN); Qi LI, Shenzhen (CN); Jing ZHOU, Shenzhen (CN); Liang MA, Shenzhen (CN)

(21) Appl. No.: 14/323,080

(22) Filed: Jul. 3, 2014

Related U.S. Application Data
(63) Continuation of application No. PCT/CN2012/087318, filed on Dec. 24, 2012.

(30) Foreign Application Priority Data
Jan. 6, 2012 (CN) 201210002869.0

(51) Int. Cl. G06Q 30/02; H04L 29/08

(52) U.S. Cl. CPC G06Q 30/0277; H04L 67/10
USPC 705/14.73

(57) ABSTRACT

A method and a client for displaying advertisements are provided. First, an advertisement configuration file is downloaded. If the advertisement configuration file is a new version of advertisement configuration file, a name of an advertisement picture resource package is extracted from the advertisement configuration file, and the corresponding advertisement picture resource package is downloaded according to the name. An advertisement display location and advertisement configuration information are parsed out from the advertisement configuration file. The advertisement configuration information includes an advertisement validity period. Advertisement configuration information within the advertisement validity period is added into an advertisement alternate playing list. An advertisement is displayed at the advertisement display location on a screen of a client according to the advertisement alternate playing list and the advertisement picture resource package. Thus, advertisements displayed at a client may be dynamically updated.

### CROSS REFERENCE TO RELATED APPLICATIONS

This application is a continuation of International Application No. PCT/CN2012/087318, filed on Dec. 24, 2012. This application claims the benefit and priority of Chinese Patent Application No. 201210002869.0 filed on Jan. 6, 2012. The entire disclosures of each of the above applications are incorporated herein by reference.

### TECHNICAL FIELD

The present disclosure relates to Internet communication technologies, particularly relates to a method and client for displaying advertisements.

### BACKGROUND

Promotion activities are often needed in product operations to enhance market popularity of products and increase user stickiness. The most common way of promotion activity is to display product advertisements.

Existing technologies provide a method for displaying advertisements: specifically, first of all, an operator embeds advertisement information to be displayed in an application program and couples advertisement realization logic to the logic framework of the application program; a user downloads the application program to a client, the client runs the application program, at the same time, runs the advertisement realization logic coupled in the application program, and displays the advertisement information embedded in the application program to the user, in order to achieve advertisement display.

In the process of realizing the present disclosure, the inventor finds that existing technologies have at least the following problems: in an operating cycle of the application program, the advertisement information embedded in the application program may not be updated, and thus existing methods for displaying advertisements may not enable dynamic update of advertisements.

### SUMMARY

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

In order to be able to dynamically update advertisements displayed by a client, the present disclosure provides a method for displaying advertisement and client. The technical solutions of the embodiments are as follows.

A method for displaying advertisements includes:

downloading an advertisement configuration file, and if the advertisement configuration file is a new version of advertisement configuration file, extracting a name of an advertisement picture resource package from the advertisement configuration file, and downloading the corresponding advertisement picture resource package according to the name;

parsing out an advertisement display location and advertisement configuration information from the advertisement configuration file, the advertisement configuration information including an advertisement validity period; and

adding advertisement configuration information within the advertisement validity period into an advertisement alternate playing list, displaying an advertisement at the advertisement display location on a screen of a client according to the advertisement alternate playing list and the advertisement picture resource package.

A client includes:

a downloading module, to download an advertisement configuration file, and if the advertisement configuration file is a new version of advertisement configuration file, extract a name of an advertisement picture resource package from the advertisement configuration file, and download the corresponding advertisement picture resource package according to the name;

a parsing module, to parse out an advertisement display location and advertisement configuration information from the advertisement configuration file, the advertisement configuration information including an advertisement validity period; and

a displaying module, to add advertisement configuration information within the advertisement validity period into an advertisement alternate playing list, display an advertisement at the advertisement display location on a screen of a client according to the advertisement alternate playing list and the advertisement picture resource package.

In the embodiment of the present disclosure, when an advertisement configuration file is downloaded, if the advertisement configuration file is a new version of advertisement configuration file, a name of an advertisement picture resource package is extracted from the advertisement configuration file, advertisement picture resource package corresponding to the name of advertisement picture resource package is downloaded; advertisement display location and advertisement configuration information are parsed out from the advertisement configuration file. Advertisement configuration information includes advertisement ID, advertisement playing mode, advertisement title, advertisement validity period, advertisement content address and link configuration information; advertisement configuration information within advertisement validity period is added into an advertisement alternate playing list, and advertisements are displayed at the advertisement display location on a screen of a client according to the advertisement alternate playing list and advertisement picture resource package, so as to dynamically update advertisements displayed at a client.

### BRIEF DESCRIPTION OF THE DRAWINGS

FIG. 1 shows a flow chart of a method for displaying advertisements according to Embodiment 1 of the present disclosure;

FIG. 2 shows a flow chart of a method for displaying advertisements according to Embodiment 2 of the present disclosure;

FIG. 3 shows a schematic diagram of a first kind of structure of a client according to Embodiment 3 of the present disclosure;

FIG. 4 shows a schematic diagram of a second kind of structure of the client according to Embodiment 3 of the present disclosure;

FIG. 5 shows a schematic diagram of a third kind of structure of the client according to Embodiment 3 of the present disclosure; and

FIG. 6 shows a schematic diagram of a fourth kind of structure of the client according to Embodiment 3 of the present disclosure.

### DETAILED DESCRIPTION

In order to better clarify the purpose, technical solutions and advantages of the present disclosure, modes of implementing the present disclosure is further described in detail below in combination with attached figures.

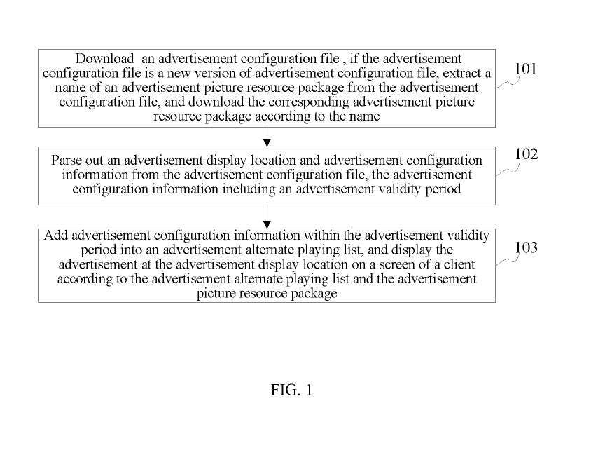

FIG. 1 shows a flow chart of a method for displaying advertisements according to an embodiment of the present disclosure. As shown in FIG. 1, the method includes the following process.

At block 101, an advertisement configuration file is downloaded, if the advertisement configuration file is a new version of advertisement configuration file, a name of an advertisement picture resource package is extracted from the advertisement configuration file, and the corresponding advertisement picture resource package is downloaded according to the name.

At block 102, an advertisement display location and advertisement configuration information are parsed out from the advertisement configuration file, the advertisement configuration information including an advertisement validity period.

Optionally, the advertisement configuration information may also include at least one of the information: advertisement ID, advertisement playing mode, advertisement title, advertisement content address, and link configuration information.

At block 103, advertisement configuration information within the advertisement validity period is added into an advertisement alternate playing list, and an advertisement is displayed at an advertisement display location on a screen of a client according to the advertisement alternate playing list and the advertisement picture resource package.

In the embodiment of the present disclosure, when an advertisement configuration file is downloaded, if the advertisement configuration file is a new version of advertisement configuration file, a name of an advertisement picture resource package is extracted from the advertisement configuration file, and the corresponding advertisement picture resource package is downloaded according to the name; an advertisement display location and advertisement configuration information are parsed out from the advertisement configuration file. The advertisement configuration information includes advertisement ID, advertisement playing mode, advertisement title, advertisement validity period, advertisement content address and link configuration information; advertisement configuration information within the advertisement validity period is added into an advertisement alternate playing list, and an advertisement is displayed at the advertisement display location on a screen of a client according to the advertisement alternate playing list, and the advertisement picture resource package, so as to dynamically update advertisements at the client.

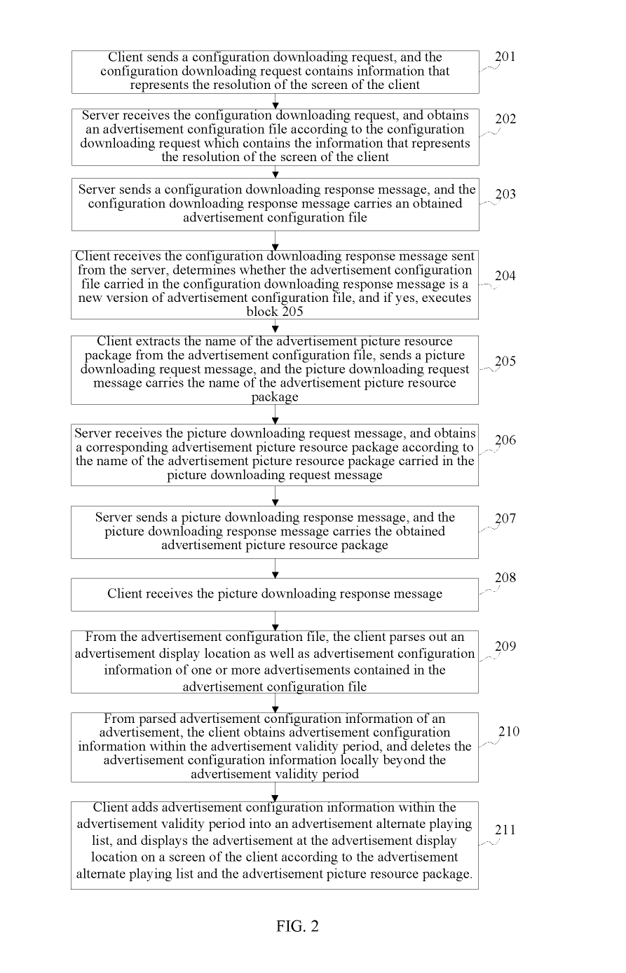

FIG. 2 shows a flow chart of a method for displaying advertisements according to another embodiment of the present disclosure. As shown in FIG. 2, the method includes the following process.

At block 201, a client sends a configuration downloading request, and the configuration downloading request contains information that represents resolution of a screen of the client.

The client obtains the information that represents the resolution of the screen of the client, and then sends the configuration downloading request which contains the information that represents the resolution of the screen of the client to a server.

When the client starts an application program, the client may send the configuration downloading request to the server.

For example, the client obtains the information “a” that represents the resolution of the screen of the client, and sends the information “a” that represents the resolution of the screen of the client to the server.

At block 202, the server receives the configuration downloading request, and obtains an advertisement configuration file according to the configuration downloading request which contains the information that represents the resolution of the screen of the client.

Specifically, the server receives the configuration downloading request, and searches for corresponding relationships between stored screen resolution and advertisement configuration files, according to the configuration downloading request which contains the information that represents the resolution of the screen of the client; if a corresponding advertisement configuration file is searched out, then obtains the advertisement configuration file corresponding to the information that represents the resolution of the screen of the client, and if a corresponding advertisement configuration file fails to be searched out, then obtains an advertisement configuration file corresponding to universal screen resolution.

Clients with different screen resolution have different locations and modes for displaying advertisements, and technical personnel regularly configure advertisement configuration files corresponding to currently commonly used several kinds of screen resolution, and store each commonly used screen resolution and an advertisement configuration file configured for each commonly used screen resolution in the corresponding relationships between screen resolution and the advertisement configuration files. In addition, technical personnel also regularly configure advertisement configuration files corresponding to the universal screen resolution.

An advertisement configuration file includes a version number, a name of an advertisement picture resource package, an advertisement display location and advertisement configuration information of one or more advertisements; the advertisement configuration information includes an advertisement ID, an advertisement title, an advertisement playing mode, an advertisement validity period, an advertisement content address and link configuration information; furthermore, advertisement configuration information may also include advertisement display time.

The advertisement configuration file corresponds to one or more advertisement picture resource packages, and a name or names of one or more advertisement picture resource packages are stored in the advertisement configuration file. The advertisement picture resource package stores advertisement content which may be pictures or an animation and is in one-to-one correspondence to advertisement content addresses; the advertisement playing mode includes continuous playing or only playing once; the advertisement validity period is a period from advertisement start time to advertisement end time, for example, when start time of an advertisement is T1, and its end time is T2, the advertisement validity period of the advertisement is a period from T1 to T2; the link configuration information may include a webpage skip address or message content, and may also include an advertisement display type. The advertisement display type includes web page display and message box display.

For example, it is supposed that, currently several common kinds of screen resolution includes screen resolution a, b, c and d, technical personnel regularly configure advertisement configuration files a, b, c and d corresponding to screen resolution a, b, c and d respectively, and store the screen resolution a, b, c and d as well as the advertisement configuration files a, b, c and d corresponding to the screen resolution a, b, c and d respectively in corresponding relationships between screen resolution and advertisement configuration files as shown in Table 1; in addition, technical personnel also regularly configure advertisement configuration file e corresponding to universal screen resolution.

TABLE 1

| Screen Resolution | Advertisement Configuration File |
|---|---|
| a | Advertisement configuration file a |
| b | Advertisement configuration file b |
| c | Advertisement configuration file c |
| d | Advertisement configuration file d |

The server receives the configuration downloading request sent from the client, searches the corresponding relationship between screen resolution and advertisement configuration files as shown in Table 1 according to information “a” that represents the resolution of the screen of the client contained in the configuration downloading request, and searches the corresponding advertisement configuration file a.

At block 203, the server sends a configuration downloading response message, and the configuration downloading response message contains an obtained advertisement configuration file.

For example, the server sends a configuration downloading response message, and the configuration downloading response message contains the searched advertisement configuration file “a”. The advertisement configuration file “a” includes a version number, Verson2, a name of advertisement picture resource package, Name2, an advertisement display location, Location, advertisement configuration information of advertisement 1, Info1, advertisement configuration information of advertisement 2, Info 2, and advertisement configuration information of advertisement 3, Info 3. The advertisement configuration information of advertisement 1, Info1, includes an advertisement ID, ID1, an advertisement title, titile1, an advertisement playing mode which is continuous playing, an advertisement validity period which is a period of time from t11 to t12, an advertisement content address, IP1, and link configuration information which is a webpage skip address URL1. The advertisement configuration information of advertisement 2, Info 2, includes an advertisement ID, ID2, an advertisement title, title 2, an advertisement playing mode which is continuous playing, an advertisement validity period which is a period of time from t21 to t22, an advertisement content address, IP2, and link configuration information which is a webpage skip address URL2. The advertisement configuration information of advertisement 3, Info3, includes an advertisement ID, ID3, an advertisement title, title 3, an advertisement playing mode which is continuous playing, an advertisement validity period which is a period of time from t31 to t32, an advertisement content address, IP3, and link configuration information which is a webpage skip address URL3.

At block 204, the client receives the configuration downloading response message sent from the server, determines whether the advertisement configuration file carried in the configuration downloading response message is a new version of advertisement configuration file, and if yes, executes block 205.

Specifically, the client receives the configuration downloading response message sent from the server, extracts a version number from the advertisement configuration file contained in the configuration download response message, and compares the extracted version number and a version number of an advertisement configuration file which has been stored locally. If the two are same, it is determined that the advertisement configuration file has been stored locally, that is, the advertisement configuration file is not a new version of advertisement configuration file, and if the two are not same, it is determined that the advertisement configuration file has not been stored locally, that is, the advertisement configuration file is a new version of advertisement configuration file.

If it is determined that the advertisement configuration file is not a new version of advertisement configuration file, the advertisement configuration file is discarded directly.

For example, the client receives a configuration downloading response message which contains advertisement configuration file a, and extracts a version number Version2 from the advertisement configuration file a. It is supposed that, the version number of the advertisement configuration file stored locally is Version1, the client compares the version number Version1 of the advertisement configuration file stored locally with extracted version number Version2. If the two are compared not same, it is determined that the advertisement configuration file a is a new version of advertisement configuration file.

The advertisement configuration file corresponds to one or more advertisement picture resource packages; further, if it is determined that the advertisement configuration file contained in the configuration downloading response message is a new version of advertisement configuration file, the client deletes the advertisement configuration file stored locally, deletes one or more advertisement picture resource packages corresponding to the advertisement configuration file stored locally, and then stores the advertisement configuration file contained in the configuration downloading response message.

At block 205, the client extracts the name of the advertisement picture resource package from the advertisement configuration file, sends a picture downloading request message, and the picture downloading request message carries the name of the advertisement picture resource package.

For example, the client extracts an advertisement picture resource package Name2 from the advertisement configuration file a, sends a picture downloading request message to the server, and the picture downloading request message contains the name of the advertisement picture resource package Name2.

At block 206, the server receives the picture downloading request message, and obtains a corresponding advertisement picture resource package according to the name of the advertisement picture resource package carried in the picture downloading request message.

When an operator configures an advertisement configuration file on a regular basis, the operator also configures one or more advertisement picture resource packages corresponding to the advertisement configuration file.

In the embodiment, the sizes of the advertisement configuration files are small, generally with capacities of only a few KBs or tens of KBs, while the advertisement picture resource packages have larger sizes.

At block 207, the server sends a picture downloading response message, and the picture downloading response message carries the obtained advertisement picture resource package.

For example, the server receives the picture downloading request message sent from the client, the picture downloading request message containing the name of the advertisement picture resource package Name2, obtains corresponding the advertisement picture resource package according to the name of the advertisement picture resource package Name2 which is supposed to be advertisement picture resource package A; and sends a picture downloading response message which contains an advertisement picture resource package A.

At block 208, the client receives the picture downloading response message.

After receiving the picture downloading response message, the client stores the advertisement picture resource package contained in the picture downloading response message. For example, the client receives a picture downloading response message which contains advertisement picture resource package A, and stores advertisement picture resource package A.

At block 209, from the advertisement configuration file, the client parses out an advertisement display location as well as advertisement configuration information of one or more advertisements contained in the advertisement configuration file.

The advertisement configuration information may include advertisement ID, advertisement title, advertisement playing mode, advertisement validity period, advertisement content address, advertisement display type and link configuration information, and may also include advertisement display time.

For example, from the advertisement configuration file a, the client parses out advertisement display location, Location, advertisement configuration information of advertisement 1, Info1, advertisement configuration information of advertisement 2, Info2, and advertisement configuration information of advertisement 3, Info3; in which the advertisement configuration information of advertisement 1, Info1, includes an advertisement ID, ID1, an advertisement title, title1, an advertisement playing mode which is continuous playing, an advertisement validity period which is a period of time from t11 to t12, an advertisement content address, IP1, and link configuration information which is a webpage skip address, URL1; advertisement configuration information Info 2 of advertisement 2 includes advertisement ID2, an advertisement title, title 2, an advertisement playing mode which is continuous playing, an advertisement validity period which is a period of time from t21 to t22, an advertisement content address, IP2, and link configuration information which is a webpage skip address URL2; advertisement configuration information of advertisement 3, Info3, includes an advertisement ID, ID3, an advertisement title, title 3, an advertisement playing mode which is playing-once, an advertisement validity period which is a period of time from t31 to t32, an advertisement content address, IP3, and link configuration information which is a webpage skip address, URL3.

At block 210, from parsed advertisement configuration information of an advertisement, the client obtains advertisement configuration information within the advertisement validity period, and deletes the advertisement configuration information locally beyond the advertisement validity period.

Specifically, the client obtains current time, according to the obtained current time, from the parsed advertisement configuration information, separates advertisement configuration information within the advertisement validity period and advertisement configuration information beyond the advertisement validity period, and deletes the advertisement configuration information beyond the advertisement validity period from the advertisement configuration file.

For any parsed advertisement configuration information, it is determined whether the playing validity period contained in the advertisement configuration information includes the current time, if yes, it is determined that the advertisement configuration information is within the advertisement validity period, if not, it is determined that the advertisement configuration information is beyond the advertisement validity period.

For example, from parsed advertisement configuration information of advertisement 1, Info1, advertisement configuration information of advertisement 2, Info2, and advertisement configuration information of advertisement 3, Info3, the client obtains the advertisement configuration information of advertisement 1, Info1, the advertisement configuration information of advertisement 2, Info2, and the advertisement configuration information of advertisement 3, Info3, within the advertisement validity period.

At block 211, the client adds advertisement configuration information within the advertisement validity period into an advertisement alternate playing list, and displays the advertisement at the advertisement display location on a screen of the client according to the advertisement alternate playing list and the advertisement picture resource package.

Specifically, the client adds advertisement configuration information within advertisement validity period into an advertisement alternate playing list, and displays advertisements at the advertisement display location on a screen of a client according to the advertisement alternate playing list and the advertisement picture resource package, by adopting the following steps (1) through (3).

(1) The client sets a pointer to point at the first line of advertisement configuration information in the advertisement alternate playing list.

For example, the client may add advertisement configuration information of advertisement 1, Info1, advertisement configuration information of advertisement 2, Info2, and advertisement configuration information of advertisement 3, Info3, into the advertisement alternate playing list as shown in Table 2, and sets the pointer to point at the first line of advertisement configuration information in the advertisement alternate playing list as shown in Table 2, that is, advertisement configuration information of advertisement 1, Info1.

TABLE 2
Advertisement Configuration Information

| | | | | Advertisement | Link |
|---|---|---|---|---|---|
| Advertisement | Advertisement | Advertisement | Advertisement | Content | Configuration |
| ID | Title | Playing Mode | Validity Period | Address | Information |
| ID1 | title1 | Continuous | From t11 to t12 | IP1 | URL1 |
| | | playing | | | |
| ID2 | title2 | Continuous | From t21 to t22 | IP2 | URL2 |
| | | playing | | | |
| ID3 | title3 | Playing only | From t31 to t32 | IP3 | URL3 |
| | | once | | | |

(2) The client reads an advertisement title and an advertisement content address from the advertisement configuration information pointed at by the pointer, obtains corresponding advertisement content from the advertisement picture resource package according to the advertisement content address, and displays the advertisement content and the advertisement title at the advertisement display location at the client; as such, advertisement display is achieved;

Specifically, the client reads an advertisement title and an advertisement content address from the advertisement configuration information pointed at by the pointer, obtains corresponding advertisement content from the advertisement picture resource package according to the advertisement content address, combines the advertisement title with the advertisement content, and displays the combined advertisement title with the advertisement content at the advertisement display location on the screen of the client;

In the present embodiment, the advertisement may be displayed based on time slice, and one or more advertisements may be displayed within a time slice.

When the advertisement is displayed, the user may click the advertisement content of the advertisement through a mouse or other input and output devices, to realize an instruction of inputting the advertisement to the client; accordingly, the client receives the user's click on the advertisement instruction, and obtains link configuration information from advertisement configuration information pointed at by the pointer; if the link configuration information includes a webpage skip address, a corresponding webpage is obtained and displayed according to the webpage skip address; and if the link configuration information includes message content, the user creates a message box and loads the message content to the message box.

For example, the client reads advertisement title title1 and advertisement content address IP1 from advertisement configuration information of advertisement 1 Info1 pointed at by the pointer, obtains corresponding advertisement content from the advertisement picture resource package A according to the advertisement content address IP1, combines the advertisement title title1 with obtained advertisement content, displays the advertisement content and the advertisement title at the advertisement display location on the screen of the client; as such, displaying advertisement 1 to a user is achieved;

When advertisement 1 is displayed, the user may click the advertisement content of advertisement 1 through a mouse to input an advertisement instruction to the client. The client receives the advertisement instruction, and obtains link configuration information URL1 from advertisement configuration information of advertisement 1 Info1 pointed at by the pointer, a corresponding webpage is obtained from network according to URL1 and displayed to the user.

(3) It is determined whether the advertisement configuration information pointed at by the pointer is the last line of advertisement configuration information, if yes, the pointer is reset to make it re-point at the first line of advertisement configuration information in the advertisement alternate playing list, and if not, the pointer is set to make it skip to the next line of advertisement configuration information in the advertisement alternate playing list.

In a next new time slice; the client begins to proceed with the above step (2).

Further, after the display of advertisements corresponding to each advertisement configuration information in the advertisement alternate playing list is completed, advertisement configuration information with the playing-once advertisement playing mode is obtained from the advertisement alternate playing list, advertisement IDs and advertisement content addresses are read out from the obtained advertisement configuration information, the advertisement configuration information containing the read out advertisement IDs is deleted from the advertisement configuration file, and advertisement content corresponding to the advertisement content addresses is deleted from the advertisement picture resource package, and the obtained advertisement configuration information is deleted from the advertisement alternate playing list.

For example, the client determines that the advertisement configuration information of advertisement 1 Info1 pointed at by the pointer is not the last line of advertisement configuration information in the advertisement alternate playing list as shown in Table 2, then it sets the pointer to point at a next line of advertisement configuration information, that is, setting the pointer to point at the advertisement configuration information of advertisement 2 Info 2; then displays advertisement 2 according to the above steps (2) and (3) within a new time slice.

After the display of advertisements corresponding to each advertisement configuration information in the advertisement alternate playing list as shown in Table 2 is completed, that is, advertisement 1, advertisement 2 and advertisement 3 corresponding to advertisement configuration information of advertisement 1 Info 1, advertisement configuration information of advertisement 2 Info 2, and advertisement configuration information of advertisement 3 Info 3 respectively are displayed in order, the client obtains advertisement configuration information Info 3 of advertisement 3 with playing-once advertisement playing mode in the advertisement alternate playing list as shown in Table 2, the client obtains the advertisement configuration information of advertisement 3 Info3 with the playing-once advertisement playing mode, and obtains advertisement ID3 and advertisement content address IP3 from configuration information Info 3 of advertisement 3, deletes advertisement configuration information of advertisement ID3 from the advertisement configuration file a stored locally, that is, deleting configuration information of advertisement 3 Info 3, and deleting advertisement content corresponding to advertisement content address IP3 from the advertisement picture resource package; then deletes advertisement configuration information of advertisement 3 Info 3 from the advertisement alternate playing list as shown in Table 2.

Further, if the advertisement configuration information of each advertisement contained in the advertisement configuration file also includes advertisement display time, the client counts display time when it displays the advertisement content and advertisement title on the screen of the client; when counted time reaches the advertisement display time, the client determines whether the advertisement configuration information which the pointer re-points at is the last line of advertisement configuration information in the advertisement alternate playing list, if yes, the client sets the pointer to re-point at the first line of advertisement configuration information in the advertisement alternate playing list, if not, sets the pointer to skip to the next line of advertisement configuration information in the advertisement alternate playing list.

Further, the client monitors the advertisement configuration information of each advertisement in the advertisement alternate playing list in real time. If advertisement configuration information beyond the advertisement validity period is monitored, the client reads out an advertisement ID and an advertisement content address from the advertisement configuration information beyond advertisement validity period, deletes advertisement configuration information containing the read out advertisement ID from the advertisement configuration file, deletes advertisement content corresponding to the advertisement content address from the advertisement picture resource package, and deletes the advertisement configuration information beyond the advertisement validity period from the advertisement alternate playing list.

In the embodiment of the present disclosure, when an advertisement configuration file is downloaded, if the advertisement configuration file is a new version of advertisement configuration file, a name of an advertisement picture resource package shall be extracted from the advertisement configuration file, the advertisement picture resource package corresponding to the name of advertisement picture resource package is downloaded; an advertisement display location and advertisement configuration information are parsed out from the advertisement configuration file. The advertisement configuration information includes advertisement ID, advertisement playing mode, advertisement title, advertisement validity period, advertisement content address and link configuration information; advertisement configuration information within the validity period of advertisement is added into an advertisement alternate playing list, and an advertisement is displayed at the advertisement display location on a screen of a client according to the advertisement alternate playing list and advertisement picture resource package, so as to dynamically update advertisements displayed at the client.

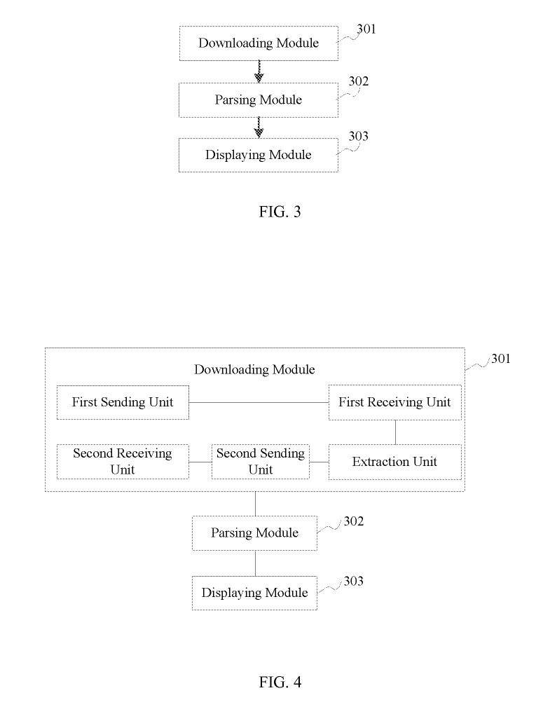

FIG. 3 shows a schematic diagram of a first kind of structure of a client according to an embodiment of the present disclosure. As shown in FIG. 3, the client may include:

a downloading module 301, configured to download an advertisement configuration file, and if the advertisement configuration file is a new version of advertisement configuration file, extract a name of an advertisement picture resource package from the advertisement configuration file, and download the corresponding advertisement picture resource package according to the name; and

a parsing module 302, configured to parse out an advertisement display location and advertisement configuration information from the advertisement configuration file, the advertisement configuration information including an advertisement validity period;

optionally, the advertisement configuration information may also include at least one of information among advertisement ID, advertisement playing mode, advertisement title, advertisement content address, and link configuration information; and

a displaying module 303, configured to add advertisement configuration information within the advertisement validity period into an advertisement alternate playing list, and display an advertisement at the advertisement display location on a screen of a client according to the advertisement alternate playing list and the advertisement picture resource package.

Optionally, the advertisement configuration information may also include at least one of information among advertisement ID, advertisement playing mode, advertisement title, advertisement content address, and link configuration information.

As shown in FIG. 4, the downloading module 301 includes:

a first sending unit, configured to send a configuration downloading request to a server, the configuration downloading request containing information that represents resolution of the screen of the client, and the server obtaining the advertisement configuration file according to the information that represents the resolution of the screen of the client; and

a first receiving unit, configured to receive a configuration downloading response message, the configuration downloading response message containing the advertisement configuration file obtained by the server.

As shown in FIG. 4, the downloading module 301 includes:

an extraction unit, configured to extract a name of an advertisement picture resource package from the advertisement configuration file, if the advertisement configuration file is a new version of advertisement configuration file;

a second sending unit, configured to send a picture downloading request message to a server, the picture downloading request message containing the name of the advertisement picture resource package, and the server obtaining the advertisement picture resource package corresponding to the name of the advertisement picture resource package; and

a second receiving unit, configured to receive a picture downloading request message, the picture downloading request message containing the advertisement picture resource package obtained by the server.

As shown in FIG. 5, the displaying module 303 includes:

an adding unit, configured to add advertisement configuration information within the advertisement validity period into an advertisement alternate playing list;

a first setting unit, configured to set a pointer to point at the first line of advertisement configuration information in the advertisement alternate playing list;

a first displaying unit, configured to read an advertisement title and an advertisement content address from the advertisement configuration information pointed at by the pointer, obtain corresponding advertisement content from the advertisement picture resource package according to the advertisement content address, and display the advertisement content and the advertisement title at the advertisement display location at the client; and

a second setting unit, configured to determine whether the advertisement configuration information pointed at by the pointer is the last line of advertisement configuration information, if yes, set the pointer to re-point at the first line of advertisement configuration information in the advertisement alternate playing list, if not, set the pointer to skip to the next line of advertisement configuration information in the advertisement alternate playing list.

As shown in FIG. 5, if the advertisement configuration information also includes display time, the displaying module 303 includes:

a third setting unit, configured to count display time when the advertisement content and the advertisement title are displayed on the screen of a client; when counted display time reaches the advertisement display time, determine whether the advertisement configuration information pointed at by the pointer is the last line of advertisement configuration information, if yes, set the pointer to re-point at the first line of advertisement configuration information in the advertisement alternate playing list, and if not, set the pointer to skip to the next line of advertisement configuration information in the advertisement alternate playing list.

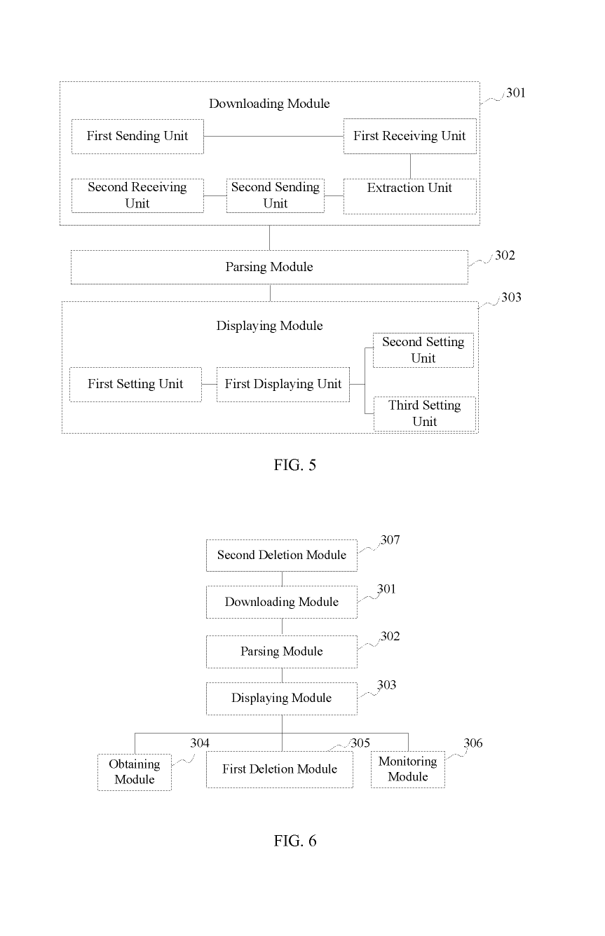

Further, as shown in FIG. 6, the client also includes:

an obtaining module 304, configured to receive a user's click operation on an advertisement instruction, and read link configuration information from advertisement configuration information pointed at by the pointer; if the link configuration information includes a webpage skip address, obtain a corresponding webpage according to the webpage skip address; and if the link configuration information includes message content, create a message box and load the message content to the message box.

Further, as shown in FIG. 6, the client also includes:

a first deletion module 305, configured to obtain advertisement configuration information with a playing-once advertisement playing mode from an advertisement alternate playing list, after the display of advertisements corresponding to the advertisement configuration information in the advertisement alternate playing list is completed, read an advertisement ID and an advertisement content address from the obtained advertisement configuration information, delete advertisement configuration information that contains the advertisement ID from the advertisement configuration file, delete advertisement content that corresponds to the advertisement content address from the advertisement picture resource package, and delete the obtained advertisement configuration information from the advertisement alternate playing list.

Further, as shown in FIG. 6, the client also includes:

a monitoring module 306, configured to monitor the advertisement alternate playing list in real time, if a monitoring result shows that the advertisement alternate playing list contains advertisement configuration information beyond the advertisement validity period, then read an advertisement ID and an advertisement content address from the advertisement configuration information, delete advertisement configuration information that contains the advertisement ID from the advertisement configuration file, and delete advertisement content that corresponds to the advertisement content address from the advertisement picture resource package, and delete the advertisement configuration information from the advertisement alternate playing list.

Further, as shown in FIG. 6, the client also includes:

a second deletion module 307, configured to delete the advertisement configuration file and the advertisement picture resource package stored at the client, if the advertisement configuration file is a new version of advertisement configuration file.

In the embodiment of the present disclosure, when an advertisement configuration file is downloaded, if the advertisement configuration file is a new version of advertisement configuration file, a name of an advertisement picture resource package is extracted from the advertisement configuration file, advertisement picture resource package corresponding to the name of advertisement picture resource package is downloaded; advertisement display location and advertisement configuration information are parsed out from the advertisement configuration file. Advertisement configuration information includes advertisement ID, advertisement playing mode, advertisement title, advertisement validity period, advertisement content address and link configuration information; advertisement configuration information within validity period of advertisement is added into an advertisement alternate playing list, and advertisements are displayed at the advertisement display location on a screen of a client according to the advertisement alternate playing list and advertisement picture resource package, so as to dynamically update advertisements displayed at the client.

Those persons having ordinary skill in the art may understand that all or part of the steps for achieving the above embodiments may be completed by hardware, and may be completed by programs instructing relevant hardware, the aforesaid programs may be stored in a computer readable storage medium why may be ROM, disc or CD-ROM, etc.

The above are only better embodiment of the present invention, and are not be used to restrict the present invention. Any modification, equivalent replacement, improvement and the like within the spirit and principle of the present invention should be contained in a protection scope of the implementation.

What is claimed is:

1. A method for displaying advertisements, comprising:
downloading an advertisement configuration file, and if the advertisement configuration file is a new version of advertisement configuration file, extracting a name of an advertisement picture resource package from the advertisement configuration file, and downloading the corresponding advertisement picture resource package according to the name;
parsing out an advertisement display location and advertisement configuration information from the advertisement configuration file, the advertisement configuration information including an advertisement validity period; and
adding advertisement configuration information within the advertisement validity period into an advertisement alternate playing list, displaying an advertisement at the advertisement display location on a screen of a client according to the advertisement alternate playing list and the advertisement picture resource package.

2. The method according to claim 1, wherein downloading the advertisement configuration file comprises:
sending a configuration downloading request to a server, the configuration downloading request containing information that represents resolution of the screen of the client, and the server obtaining the advertisement configuration file according to the information that represents the resolution of the screen of the client; and
receiving a configuration downloading response message, the configuration downloading response message carrying the advertisement configuration file obtained by the server.

3. The method according to claim 1, wherein downloading the corresponding advertisement picture resource package corresponding to the name comprises:
sending a picture downloading request message to the server, the picture downloading request message containing the name, and the server obtaining the corresponding advertisement picture resource package according to the name; and
receiving a picture downloading response message, the picture downloading response message carrying the advertisement picture resource package obtained by the server.

4. The method according to claim 1, wherein displaying the advertisement at the advertisement display location on the screen of the client according to the advertisement alternate playing list and the advertisement picture resource package comprises:
setting a pointer to point at a first line of advertisement configuration information in the advertisement alternate playing list;
reading an advertisement title and an advertisement content address from the advertisement configuration information pointed at by the pointer, obtaining corresponding advertisement content from the advertisement picture resource package according to the advertisement content address, and displaying the advertisement content and the advertisement title at the advertisement display location on the screen of the client; and
determining whether the advertisement configuration information pointed at by the pointer is a last line of advertisement configuration information, if the determination is yes, setting the pointer to re-point at the first line of advertisement configuration information in the advertisement alternate playing list, and if the determination is no, setting the pointer to skip to a next line of advertisement configuration information in the advertisement alternate playing list.

5. The method according to claim 4, wherein the advertisement configuration information further comprises advertisement display time, and displaying the advertisement at the advertisement display location on the screen of the client according to the advertisement alternate playing list and the advertisement picture resource package further comprises:
counting display time when the advertisement content and the advertisement title are displayed on the screen of the client; and
when counted display time reaches the advertisement display time, determining whether the advertisement configuration information pointed at by the pointer is the last line of advertisement configuration information, if the determination is yes, setting the pointer to re-point at the first line of advertisement configuration information in the advertisement alternate playing list, and if the determination is no, setting the pointer to skip to the next line of advertisement configuration information in the advertisement alternate playing list.

6. The method according to claim 4, further comprising:
receiving a user's click operation on an advertisement instruction, and reading link configuration information from the advertisement configuration information pointed at by the pointer; and
if the link configuration information includes a webpage skip address, obtaining a corresponding webpage according to the webpage skip address; and if the link configuration information includes message content, creating a message box and loading the message content to the message box.

7. The method according to claim 5, further comprising:
receiving a user's click operation on an advertisement instruction, and reading link configuration information from the advertisement configuration information pointed at by the pointer; and
if the link configuration information includes a webpage skip address, obtaining a corresponding webpage according to the webpage skip address; and if the link configuration information includes message content, creating a message box and loading the message content to the message box.

8. The method according to claim 4, further comprising:
after display of the advertisement corresponding to the advertisement configuration information in the advertisement alternate playing list is completed, obtaining advertisement configuration information with a playing-once advertisement playing mode, reading an advertisement ID and an advertisement content address from the obtained advertisement configuration information, deleting the advertisement configuration information that contains the advertisement ID from the advertisement configuration file, deleting advertisement content that corresponds to the advertisement content address from the advertisement picture resource package, and deleting the obtained advertisement configuration information from the advertisement alternate playing list.

9. The method according to claim 5, further comprising:
after display of the advertisement corresponding to the advertisement configuration information in the advertisement alternate playing list is completed, obtaining advertisement configuration information with a playing-once advertisement playing mode, reading an advertisement ID and an advertisement content address from the obtained advertisement configuration information, deleting the advertisement configuration information that contains the advertisement ID from the advertisement configuration file, deleting advertisement content that corresponds to the advertisement content address from the advertisement picture resource package, and deleting the obtained advertisement configuration information from the advertisement alternate playing list.

10. The method according to claim 1, wherein the steps after adding advertisement configuration information within advertisement validity period into the advertisement alternate playing list, further comprises:
monitoring the advertisement alternate playing list in real time, if a monitoring result shows that the advertisement alternate playing list contains advertisement configuration information beyond the advertisement validity period, then reading an advertisement ID and an advertisement content address from the advertisement configuration information, deleting advertisement configuration information that contains the advertisement ID from the advertisement configuration file, deleting advertisement content that corresponds to the advertisement content address from the advertisement picture resource package, and deleting the advertisement configuration information from the advertisement alternate playing list.

11. The method according to claim 1, comprising:
if the advertisement configuration file is the new version of advertisement configuration file, deleting the advertisement configuration file and the advertisement picture resource package stored at the client.

12. A client, comprising:
a downloading module, to download an advertisement configuration file, and if the advertisement configuration file is a new version of advertisement configuration file, extract a name of an advertisement picture resource package from the advertisement configuration file, and download the corresponding advertisement picture resource package according to the name;
a parsing module, to parse out an advertisement display location and advertisement configuration information from the advertisement configuration file, the advertisement configuration information including an advertisement validity period; and
a displaying module, to add advertisement configuration information within the advertisement validity period into an advertisement alternate playing list, display an advertisement at the advertisement display location on a screen of a client according to the advertisement alternate playing list and the advertisement picture resource package.

13. The client according to claim 12, wherein the downloading module comprises:
a first sending unit, to send a configuration downloading request to a server, the configuration downloading request containing information that represents resolution of the screen of the client, and the server obtaining the advertisement configuration file according to the information that represents the resolution of the screen of the client; and
a first receiving unit, to receive a configuration downloading response message, the configuration downloading response message containing the advertisement configuration file obtained by the server.

14. The client according to claim 12, wherein the downloading module comprises:
an extraction unit, to extract a name of an advertisement picture resource package from the advertisement configuration file, if the advertisement configuration file is a new version of advertisement configuration file;
a second sending unit, to send a picture downloading request message to a server, the picture downloading request message containing the name of the advertisement picture resource package, and the server obtaining the advertisement picture resource package corresponding to the name; and
a second receiving unit, to receive a picture downloading response message, the picture downloading response message containing the advertisement picture resource package obtained by the server.

15. The client according to claim 12, wherein the displaying module comprises:
an adding unit, to add advertisement configuration information within the advertisement validity period into an advertisement alternate playing list;
a first setting unit, to set a pointer to point at a first line of advertisement configuration information in the advertisement alternate playing list;
a first displaying unit, to read an advertisement title and an advertisement content address from the advertisement configuration information pointed at by the pointer, obtain corresponding advertisement content from the advertisement picture resource package according to the advertisement content address, and display the advertisement content and the advertisement title at the advertisement display location at the client; and
a second setting unit, to determine whether the advertisement configuration information pointed at by the pointer is a last line of advertisement configuration information, if the determination is yes, set the pointer to re-point at the first line of advertisement configuration information in the advertisement alternate playing list, and if the determination is no, set the pointer to skip to a next line of advertisement configuration information in the advertisement alternate playing list.

16. The client according to claim 15, wherein if the advertisement configuration information also comprises display time, the displaying module also comprises:
a third setting unit, to count display time when the advertisement content and the advertisement title are displayed on the screen of a client; when counted display time reaches the advertisement display time, determine whether the advertisement configuration information pointed at by the pointer is the last line of advertisement configuration information, if the determination is yes, set the pointer to re-point at the first line of advertisement configuration information in the advertisement alternate playing list, and if the determination is no, set the pointer to skip to the next line of advertisement configuration information in the advertisement alternate playing list.

17. The client according to claim 15, further comprising:
an obtaining module, to receive a user's click operation on an advertisement instruction, and read link configuration information from advertisement configuration information pointed at by the pointer; if the link configuration information includes a webpage skip address, obtain a corresponding webpage according to the webpage skip address; and if the link configuration information includes message content, create a message box and load the message content to the message box.

18. The client according to claim 16, further comprising:
an obtaining module, to receive a user's click operation on an advertisement instruction, and read link configuration information from advertisement configuration information pointed at by the pointer; if the link configuration information includes a webpage skip address, obtain a corresponding webpage according to the webpage skip address; and if the link configuration information includes message content, create a message box and load the message content to the message box.

19. The client according to claim 15, further comprising:
a first deletion module, to obtain advertisement configuration information with a playing-once advertisement playing mode from the advertisement alternate playing list, after display of advertisements corresponding to the advertisement configuration information in the advertisement alternate playing list is completed, read an advertisement ID and an advertisement content address from the obtained advertisement configuration information, delete advertisement configuration information that contains the advertisement ID from the advertisement configuration file, delete advertisement content that corresponds to the advertisement content address from the advertisement picture resource package, and delete the obtained advertisement configuration information from the advertisement alternate playing list.

20. The client according to claim 16, further comprising:
a first deletion module, to obtain advertisement configuration information with a playing-once advertisement playing mode from the advertisement alternate playing list, after display of advertisements corresponding to the advertisement configuration information in the advertisement alternate playing list is completed, read an advertisement ID and an advertisement content address from the obtained advertisement configuration information, delete advertisement configuration information that contains the advertisement ID from the advertisement configuration file, delete advertisement content that corresponds to the advertisement content address from the advertisement picture resource package, and delete the obtained advertisement configuration information from the advertisement alternate playing list.

21. The client according to claim 12, further comprising:
a monitoring module, to monitor the advertisement alternate playing list in real time, if a monitoring result shows that the advertisement alternate playing list contains advertisement configuration information beyond the advertisement validity period, then read an advertisement ID and an advertisement content address from the advertisement configuration information, delete advertisement configuration information that contains the advertisement ID from the advertisement configuration file, delete advertisement content that corresponds to the advertisement content address from the advertisement picture resource package, and delete the advertisement configuration information from the advertisement alternate playing list.

22. The client according to claim 12, further comprising:
a second deletion module, to delete the advertisement configuration file and the advertisement picture resource package stored at the client, if the advertisement configuration file is a new version of advertisement configuration file.
